(19) United States
(12) Patent Application Publication
(10) Pub. No.: US 2026/0291586 A1
(43) Pub. Date: Sep. 24, 2026

(54) CHANNEL METRIC BASED PRIORITIZATION IN EVENT-TRIGGERED MEASUREMENT REPORT

(71) Applicant: QUALCOMM Incorporated, San Diego, CA (US)

(72) Inventors: Doohyun SUNG, Basking Ridge, NJ (US); Changhwan PARK, San Diego, CA (US); Jelena DAMNJANOVIC, Del Mar, CA (US)

(21) Appl. No.: 19/083,248

(22) Filed: Mar. 18, 2025

(51) Int. Cl. H04B 7/06; H04W 24/02; H04W 24/10

(52) U.S. Cl. CPC H04B 7/06952; H04W 24/02; H04W 24/10

(57) ABSTRACT

A method for wireless communication at a user equipment (UE) and related apparatus are provided. In the method, the UE obtains one or more first quality metrics. Each first quality metric of the one or more first quality metrics is associated with one beam of one or more beams and one cell of one or more cells. The UE further communicates with a network entity based on a second quality metric associated with an event. The second quality metric is based on an aggregation of the one or more first quality metrics.

### TECHNICAL FIELD

The present disclosure relates generally to communication systems and, more particularly, to quality measurement and evaluation in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology and future wireless communication technologies.

These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to obtain one or more first quality metrics, where each first quality metric of the one or more first quality metrics is associated with one beam of one or more beams and one cell of one or more cells; and communicate with a network entity based on a second quality metric associated with an event. The second quality metric is based on an aggregation of the one or more first quality metrics.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to receive, from a UE, a report including an event quality metric associated with an event, where the event quality metric is based on an aggregation of one or more first quality metrics, where each first quality metric of the one or more first quality metrics is associated with one beam of one or more beams of the UE and one cell of one or more cells associated with the network entity; and communicate with the UE based on the report.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram 400 illustrating an example of deriving a per-event channel quality metric (CQM) based on per-beam CQM in accordance with various aspects of the present disclosure.

FIG. 5 is a diagram illustrating an example of a per-event CQM derivation method in accordance with various aspects of the present disclosure.

FIG. 6 is a diagram illustrating an example of a per-event CQM derivation method in accordance with various aspects of the present disclosure.

FIG. 7 is a call flow diagram illustrating a method of wireless communication in accordance with various aspects of the present disclosure.

FIG. 8 is a flowchart illustrating methods of wireless communication at a UE in accordance with various aspects of the present disclosure.

FIG. 9 is a flowchart illustrating methods of wireless communication at a UE in accordance with various aspects of the present disclosure.

FIG. 10 is a flowchart illustrating methods of wireless communication at a network entity in accordance with various aspects of the present disclosure.

FIG. 11 is a diagram illustrating an example of a hardware implementation for an example apparatus and/or UE.

FIG. 12 is a diagram illustrating an example of a hardware implementation for an example network entity.

### DETAILED DESCRIPTION

In wireless communication, a user equipment (UE) may use various layer 1 (L1) measurements to evaluate the quality of a beam or a channel, and the UE may perform various operations, such as handover, based on the L1 measurements. For example, the L1 measurements may include layer 1 (L1)-reference signal received power (L1-RSRP) or layer 1-signal-to-interference-plus-noise ratio (L1-SINR) reports, which may be used to report the beams that show the highest report metric values. However, in this reporting format, L1 measurement is based on instantaneous values, and the measurement results could be affected by noise and may be less reliable. Example aspects presented herein provide enhancements in L1 measurements. Instead of selecting the cell with the beam that has the highest value of a measurement metric, such as RSRP, reference signal received quality (RSRQ), SINR, or other applicable metrics, the enhanced L1 measurements consider a number of beams that satisfy a certain threshold for the metric to improve the reliability of L1 measurements.

Various aspects relate generally to wireless communication. Some aspects more specifically relate to quality measurement and evaluation in wireless communication. In some examples, a UE obtains one or more first quality metrics. Each first quality metric of the one or more first quality metrics may be associated with one beam of one or more beams and one cell of one or more cells. The UE further communicates with a network entity based on a second quality metric associated with an event. The second quality metric may be based on an aggregation of the one or more first quality metrics. In some aspects, the UE may first aggregate the one or more first quality metrics across the one or more cells to obtain one or more per-beam quality metrics, where each per-beam quality metric of the one or more per-beam quality metrics corresponds to one beam of the one or more beams. Then, the UE may aggregate the one or more per-beam quality metrics to obtain the second quality metric. In some aspects, the UE may first aggregate the one or more first quality metrics across the one or more beams to obtain one or more per-cell quality metrics, where each per-cell quality metric of the one or more per-cell quality metrics corresponds to one cell of the one or more cells. Then, the UE may aggregate the one or more per-cell quality metrics to obtain the second quality metric. In some aspects, when aggregating the one or more first quality metrics, the UE may first identify the highest first quality metric among the one or more first quality metrics. Then, the UE may obtain at least one first quality metric from the one or more first quality metric based on a threshold range to the highest first quality metric, and combine the at least one first quality metric to obtain the one or more per-cell quality metrics or per-beam quality metrics.

Particular aspects of the subject matter described in this disclosure can be implemented to realize one or more of the following potential advantages. In some examples, by introducing per-event channel quality metric (CQM) for event-triggered L1 measurement reports in lower-layer-triggered mobility (LTM) and computing the per-event CQM from multiple beams instead of reporting the best instantaneous measurement, the described techniques improve the reliability of mobility events and reduce the impact of noisy or fluctuating L1 measurements. In some examples, by introducing configurable thresholds for selecting multiple strong beams and cells, the described techniques provide a customizable method that can be adapted to various network conditions and configurations, thereby improving the adaptability and robustness of measurements. In some examples, by incorporating beam and cell prioritization based on prior transmission configuration indicator (TCI) state activation and/or early timing advance (TA) acquisition, the described techniques ensure that resources already optimized for fast switching are given higher priority, thereby enhancing the efficiency of LTM procedures.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

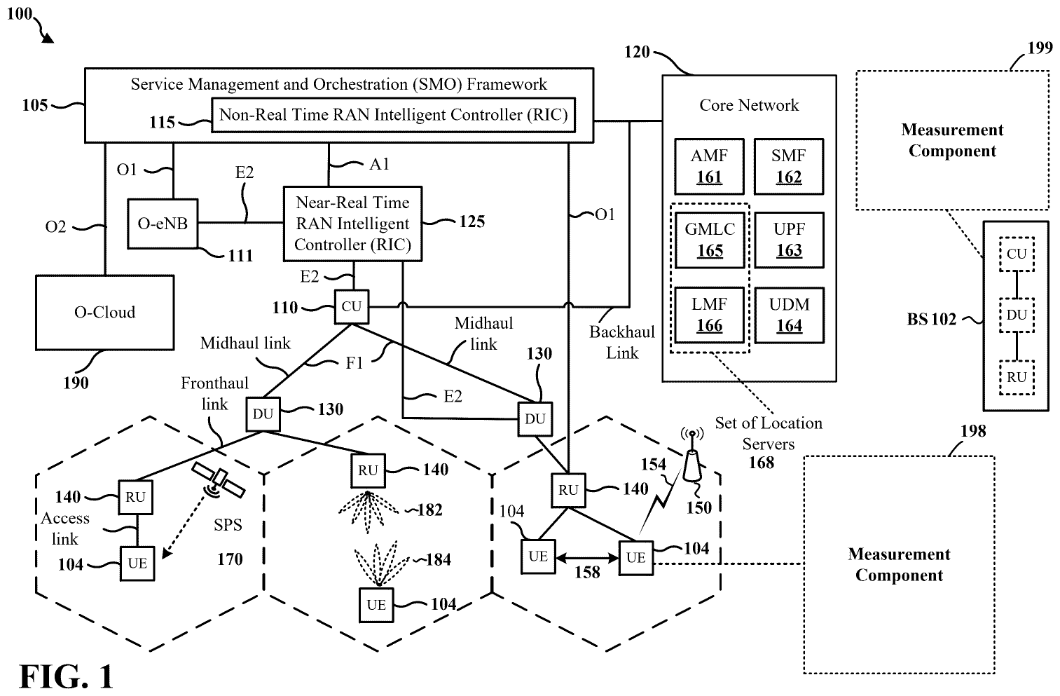

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the measurement component 198. The measurement component 198 may be configured to obtain one or more first quality metrics, where each first quality metric of the one or more first quality metrics is associated with one beam of one or more beams and one cell of one or more cells; and communicate with a network entity based on a second quality metric associated with an event. The second quality metric is based on an aggregation of the one or more first quality metrics. In certain aspects, the base station 102 may include the measurement component 199. The measurement component 199 may be configured to receiving, from a UE, a report including an event quality metric associated with an event, where the event quality metric is based on an aggregation of one or more first quality metrics, where each first quality metric of the one or more first quality metrics is associated with one beam of one or more beams of the UE and one cell of one or more cells associated with the network entity; and communicate with the UE based on the report. Although the following description may be focused on 5G NR, the concepts described herein may be applicable to other similar areas, such as LTE, LTE-A, CDMA, GSM, and other wireless technologies.

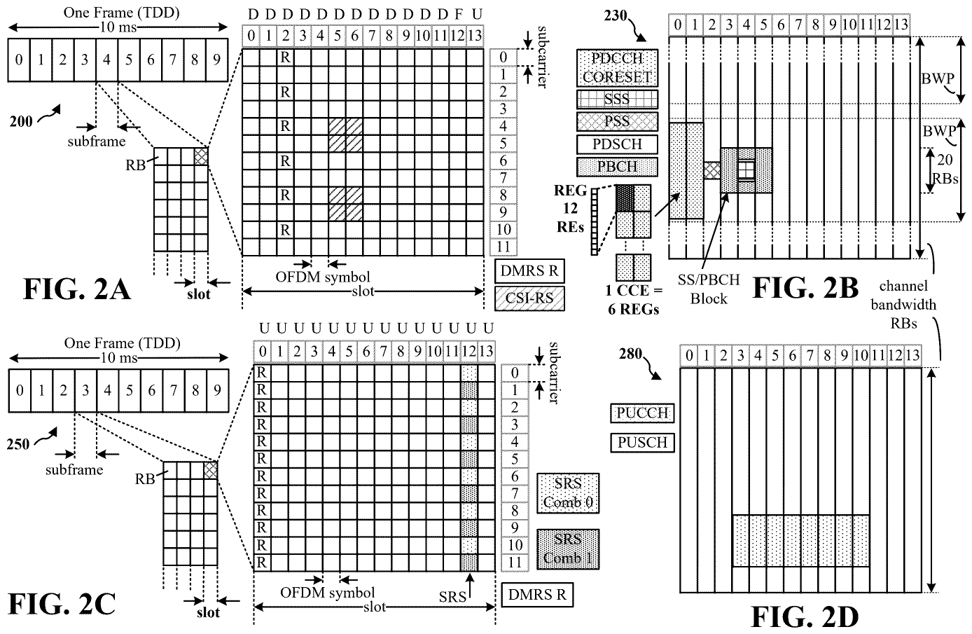

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

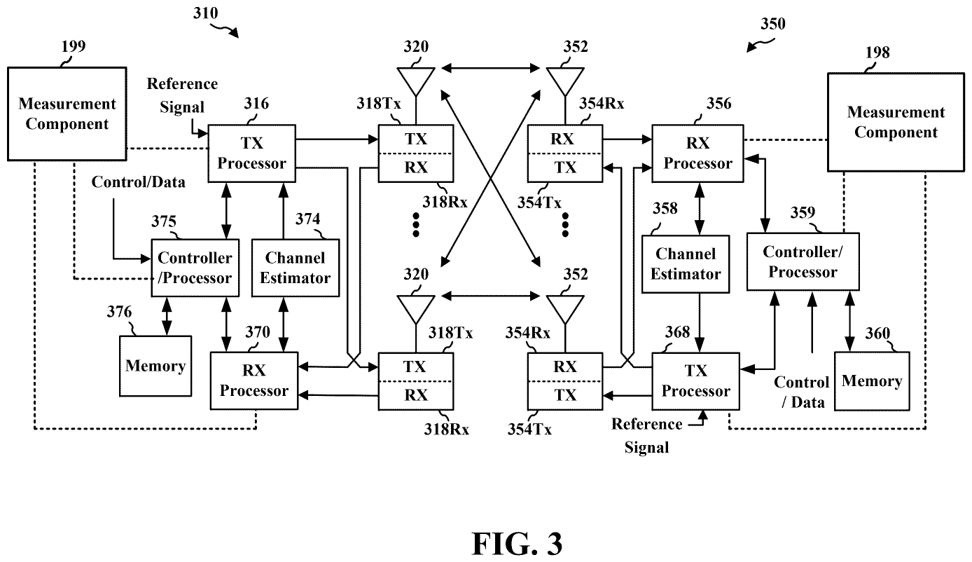

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the measurement component 198 of FIG. 1.

At least one of the TX processor 316, the RX processor 370, and the controller/processor 375 may be configured to perform aspects in connection with the measurement component 199 of FIG. 1.

In wireless communication, a UE may use various L1 measurements to evaluate the quality of a beam or a channel, and the UE may perform various operations, such as handover, based on the L1 measurements. For example, the L1 measurements may include L1-RSRP or L1-SINR reports, which may be used to report the beams that show the highest report metric values. As an example, following the uplink control information (UCI) RSRP report format, the highest RSRP may be reported with 7-bit representation, and the remaining RSRP values may be reported with 4-bit representation using a differential mapping.

In some examples, L1 event-triggered (or event-driven) measurement reports may be used for lower-layer-triggered mobility (LTM) and intra-CU conditional LTM. For example, event-triggered L1 measurement may be used to support various purposes in LTM, including selecting the candidate beam or cell to trigger early synchronization and selecting the target beam or cell to trigger the LTM cell switch procedure. For event-triggered L1 measurement, the beam-/level measurement results may be used for event evaluation. The LTM events that can be used in the event-triggered L1 measurement report are based on the beam-specific quality of the serving cell and candidate cells. For example, the example LTM events may include the beam of the serving cell becomes worse than an absolute threshold (referred to as LTM2 event), the beam of a candidate cell becomes better than the beam of the serving cell by an offset (referred to as LTM3 event), the beam of a candidate cell becoming better than an absolute threshold (referred to as LTM4 event), or the beam of the serving cell becomes worse than a first absolute threshold and the beam of a candidate cell becomes better than a second absolute threshold (referred to as LTM5 event).

In some examples, the beam configurations of both synchronization signal block (SSB) and channel state information-reference signal (CSI-RS) may be provided in the L1 measurement resource configuration within the LTM configuration. In some examples, the L1 measurement results may be filtered, for example, based on network decision or UE implementation. In some examples, the LTM events that can be used in the event-triggered L1 measurement report may be used as the conditional LTM execution condition for LTM. For example, the events that can be used as the execution condition for LTM may include the beam of a candidate cell becomes better than the beam of the serving cell by an offset, or the beam of the serving cell becomes worse than a first absolute threshold and the beam of a candidate cell becomes better than a second absolute threshold.

In some examples, the source cell and each candidate cell may provide their own execution conditions for conditional LTM. In some examples, the distributed unit (DU) may generate the L1 execution condition. In some examples, the conditional LTM can be RACH-less conditional intra-CU LTM or RACH-based conditional intra-CU LTM. In some examples, a UE-based timing advance (TA) measurement mechanism may be supported for conditional intra-CU LTM. In some examples, PDCCH-ordered early TA acquisition may be supported for conditional LTM. In some examples, early candidate transmission configuration indicator (TCI) state activation and deactivation may be supported for conditional intra-CU LTM. For RACH-less conditional LTM, configured grant (CG)-based first uplink (UL) transmission on the target cell may be supported. In some examples, the LTM completion procedure in intra-CU LTM may be reused for conditional LTM.

In some examples, the channel state information (CSI) L1-RSRP or L1-SINR report may be used to report the beams that show the highest report metric values. For example, via a differential report format, the highest report metric (e.g., the highest L1-RSRP or L1-SINR) may be represented using 7 bits, while the remaining metrics (e.g., the remaining L1-RSRP or L1-SINR) may be represented using 4 bits.

However, this reporting approach may introduce certain drawbacks for the event-triggered LTM L1 measurement report and conditional LTM. For example, L1 measurement is based on instantaneous values compared to higher layer (e.g., layer 3 or L3) measurement. Hence, L1 measurement results may be affected by noise. From the perspective of LTM cell switch, a candidate cell that has several beams with relatively good measurement results may be more reliable than a candidate cell that has a single beam with a higher measurement result, due to the potential noise in the measurements. From the perspective of conditional LTM, the base station may need to know the report metric values for beams on which early TCI state activation and/or early TA acquisition has been performed. These considerations are important for prioritizing the event, cell, or beam when generating the event-triggered LTM L1 measurement report or executing conditional LTM. Example aspects presented herein propose enhancements in L1 measurements for LTM handoffs. Instead of selecting the cell with the beam that has the best value of a measurement metric, such as RSRP, RSRQ, SINR, or other applicable metrics, example methods presented take into account a number of beams that meet a certain threshold for the metric. For example, one cell (e.g., cell 1) may have the highest value on a single beam but no other beams meeting the threshold, while another cell (e.g., cell 2) may have multiple beams, such as three beams, that meet the criteria, even though none of these beams individually have the highest metric value. This concept is further applied to the aggregation and hierarchy of metrics, enabling more comprehensive and reliable evaluation and prioritization based on the collective quality of beams rather than relying solely on a single highest measurement.

In some aspects, when multiple event conditions (e.g., LTM2, LTM3, LTM4, or LTM5 events) are fulfilled, a channel quality metric (CQM) may be computed to prioritize the reports of the triggered events (e.g., LTM2, LTM3, LTM4, or LTM5 events) to be included in the allocated PUSCH resource. For each fulfilled event, a per-event CQM may be derived either by aggregating per-beam CQM values across all cells, referred to as flattened per-beam CQM, or by aggregating per-cell CQM values after first aggregating the per-beam CQM of the member beams within each cell. As used herein, the term “per-beam CQM” may refer to the CQM obtained based on quality metric values on one beam, and the term “per-cell CQM” may refer to the CQM obtained based on quality metric values on one cell.

In some examples, the input metric used for per-beam CQM derivation can be the same metric type as the report metric. For example, when L1-RSRP is used as the report metric for the per-beam CQM, the input metric used for obtaining the per-beam CQM may also be L1-RSRP. In some examples, the input metric used for per-beam CQM derivation may have a metric type different from that of the report metric. For example, when L1-RSRP is used as the report metric for the per-beam CQM, the input metric used for obtaining the per-beam CQM may be using L1-SINR, which is a different metric type than L1-RSRP. In some examples, the per-beam CQM may be expressed in units of dB, such as SNR, SINR, or RSRQ, or in dBm, such as RSRP. In some examples, a separate filtering process may be applied for per-beam CQM derivation, which may differ from the filtering process used for report metric derivation. In some examples, when the input metric used for per-beam CQM derivation has a different metric type than that of the report metric, the UE may either be configured with explicit measurement resources or compute the metric on its own, depending on UE implementation, which can be communicated through UE capability signaling with the network. In some examples, the input metric used for per-beam CQM derivation, such as L1-RSRP or L1-SINR, may be obtained directly from actual measurement results. In some examples, the input metric may be obtained from the prediction or inference results from a model (e.g., an artificial intelligence/machine learning (AI/ML) model). In some examples, the input metric may be obtained based on a combination of actual measurement results and the prediction or inference results from a model (e.g., an AI/ML model).

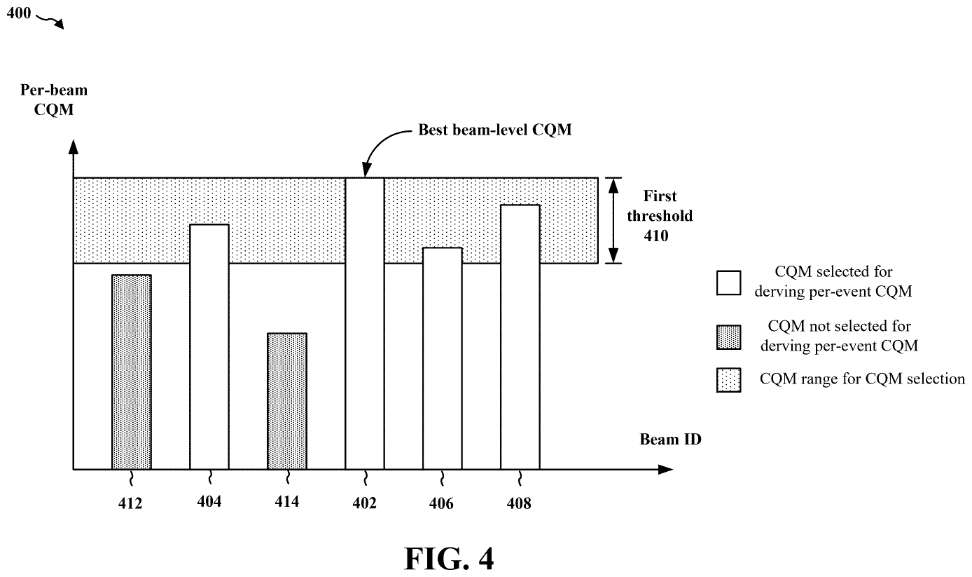

The per-event CQM may be obtained in different ways. In some aspects, a per-event CQM may be derived from per-beam CQM. FIG. 4 is a diagram 400 illustrating an example of deriving a per-event CQM based on per-beam CQM in accordance with various aspects of the present disclosure. As shown in FIG. 4, in the procedure for deriving per-event CQM from per-beam CQM, the UE may first identify the best beam (e.g., beam 402) that shows the highest per-beam CQM value (e.g., the highest L1-RSRP or L1-SINR). In some examples, the UE may be configured with a threshold X (e.g., first threshold 410), and the UE may further identify the beams that have CQM values greater than or equal to the value of the best CQM minus the threshold X (i.e., the beams that have CQM values with a difference from the highest per-beam CQM value that is less than or equal to the threshold X). For example, in the example in FIG. 4, the UE may further identify beams 404, 406, 408, which have CQM values with a difference from the highest per-beam CQM value (e.g., at beam 402) that is less than or equal to the first threshold 410. On the other hand, beams 412, 414 may be excluded when deriving the per-event CQM, since the CQM values for these beams fall outside the range from the highest per-beam CQM value (e.g., at beam 402) defined by the first threshold 410.

In some examples, the threshold X may not be configured for the UE or the threshold X may be set to zero. In these cases, the CQM of the best beam (e.g., beam 402) is used, and the UE may not need to further identify other beams that have CQM values within a range of the best CQM defined by the threshold X.

The UE then may combine the selected per-beam CQM values (e.g., CQM values for beams 402, 404, 406, and 408) through weighted averaging to derive the per-event CQM. In some examples, the weights applied during this weighed averaging process (e.g., the weights respectively applied to beams 402, 404, 406, 408) can be explicitly configured by the network. In some examples, the weights may be predefined values (e.g., values defined in a communication standard). In some examples, the weights may be determined by the UE.

In some examples, across triggered events (e.g., LTM2, LTM3, LTM4, or LTM5), the per-event CQM, the best beam CQM (e.g., the CQM for beam 402), or the number of beams satisfying the threshold (e.g., first threshold 410) can be used to determine the priority of the triggered event (e.g., the priority of the triggered event LTM2, LTM3, LTM4, or LTM5). In some examples, the prioritization of the triggered events may be based exclusively on the best per-event CQM. In some examples, the prioritization of the triggered events may be based exclusively on the best beam-level CQM (e.g., per-beam CQM), for example, when no threshold (e.g., first threshold 410) has been configured. In some examples, the prioritization of the triggered events may be based on the number of beams that satisfy the threshold (e.g., first threshold 410). For example, in FIG. 4, the number of beams that satisfy the threshold (e.g., first threshold 410) may be four (e.g., beams 402, 404, 406, 408). In some examples, when the prioritization of the triggered events is based on factors other than the value of the per-event CQM (e.g., the best per-beam CQM or the number of beams that satisfy the threshold), the per-event CQM computation may be skipped.

In some aspects, a per-event CQM may be derived from per-cell CQM, which may be obtained from per-beam CQM. In this case, the per-beam CQM may first be aggregated, based on their associated cells, to form the per-cell CQM, and the per-cell CQM may be further aggregated to obtain the per-event CQM. In some examples, two different thresholds may be applied: a threshold Y for selecting beams within each cell and a threshold Z for selecting cells.

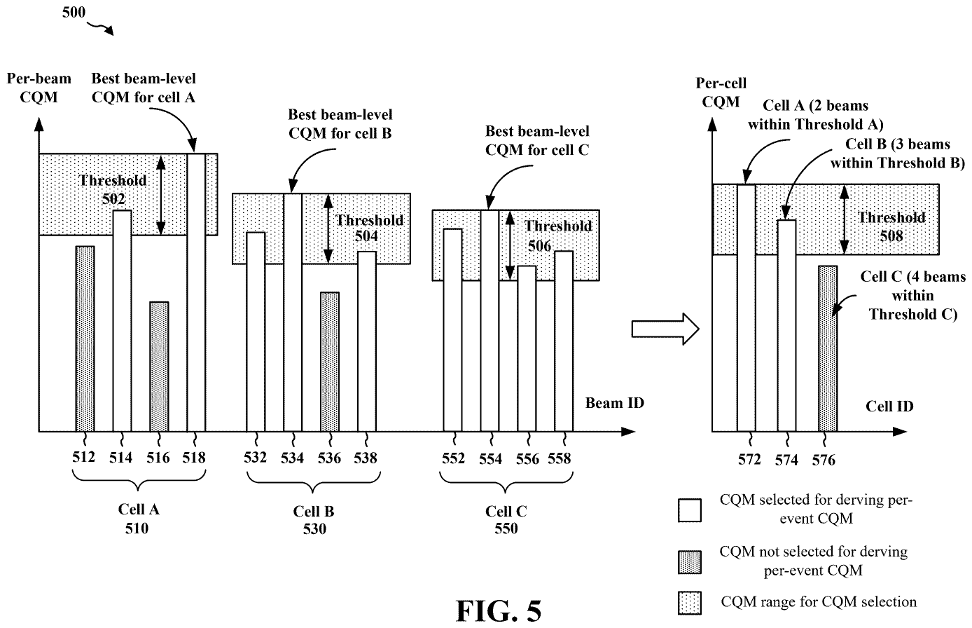

In this method, instead of flattening beam structure, the beams are first categorized within each cell. When deriving the per-event CQM, the UE may first identify the best beam with the highest per-beam CQM value for each cell. FIG. 5 is a diagram 500 illustrating an example of a per-event CQM derivation method in accordance with various aspects of the present disclosure. As shown in FIG. 5, the UE may first identify the best beam with the highest per-beam CQM value for each cell of the three cells (e.g., cell A 510, cell B 530, cell C 550). For example, the UE may identify beam 518 as the best beam with the highest per-beam CQM for cell A 510, identify beam 534 as the best beam with the highest per-beam CQM for cell B 530, and identify beam 554 as the best beam with the highest per-beam CQM for cell C 550.

In some examples, the UE may be configured with the threshold Y for selecting beams within each cell, and the UE may identify the beams within that cell that have CQM values greater than or equal to the best per-beam CQM in the cell minus Y (i.e., the beams within that cell that have CQM values with a difference from the highest per-beam CQM value of that cell that is less than or equal to the threshold Y). For example, in FIG. 5, the UE may identify the beam 514, 518 within cell A 510 that has CQM values greater than or equal to the best per-beam CQM (e.g., at beam 518) in the cell A 510 minus threshold 502, identify the beams 532, 538 within cell B 530 that have CQM values greater than or equal to the best per-beam CQM (e.g., at beam 534) in the cell B 530 minus threshold 504, and identify the beams 552, 556, 558 within cell C 550 that have CQM values greater than or equal to the best per-beam CQM (e.g., at beam 554) in the cell C 550 minus threshold 506. On the other hand, the UE may not identify the beam 512, 516 within cell A 510 since their CQM values fall outside of the range defined by best per-beam CQM (e.g., at beam 518) in the cell A 510 and the threshold 502. Similarly, for cell B 530, the UE may not identify the beam 536 within cell B 530 since its CQM value falls outside of the range defined by best per-beam CQM (e.g., at beam 534) in the cell B 530 and the threshold 504. In some examples, the thresholds for different cells (e.g., threshold 502, 504, 506) may have the same value. In some examples, the thresholds for different cells (e.g., threshold 502, 504, 506) may have different values.

In some examples, the threshold Y (e.g., threshold 502, 504, 506) may not be configured for a cell or the threshold Y (e.g., threshold 502, 504, 506) may be set to zero for a cell. In these cases, the UE may not need to further identify other beams that have CQM values within a range of the best CQM defined by the threshold Y for that cell.

The UE then may combine the selected per-beam CQM values through weighted averaging to derive the per-cell CQM for each cell. For example, for cell A 510, the UE may combine the selected per-beam CQM values (e.g., CQM values for beams 514, 518) to derive the per-cell CQM (e.g., at 572) for cell A 510. For cell B 530, the UE may combine the selected per-beam CQM values (e.g., CQM values for beams 532, 534, 538) to derive the per-cell CQM (e.g., at 574) for cell B 530. For cell C 550, the UE may combine the selected per-beam CQM values (e.g., CQM values for beams 552, 554, 556, 558) to derive the per-cell CQM (e.g., at 576) for cell C 550.

In some examples, the weight used in the weighted averaging process can be explicitly configured by the network. In some examples, the weights may be predefined values (e.g., values defined in a communication standard). In some examples, the weights may be determined by the UE.

After calculating the per-cell CQM values for each cell (e.g., cell A 510, cell B 530, cell C 550), the UE may identify the best cell with the highest per-cell CQM value. For example, in FIG. 5, the UE may identify cell A 510 as the best cell with the highest per-cell CQM value (e.g., at 572). In some examples, the UE may be configured with a threshold Z (e.g., threshold 508), and the UE may identify the cells that have CQM values greater than or equal to the best per-cell CQM minus Z (i.e., the cells that have CQM values with a difference from the highest per-cell CQM value that is less than or equal to the threshold Z). For example, in FIG. 5, the UE may identify cell B 530 that has the per-cell CQM value greater than or equal to the best per-cell CQM (e.g., per-cell CQM for cell A 510 at 572) minus threshold 508. The UE then may combine the per-cell CQM values through weighted averaging to derive the per-event CQM. For example, in FIG. 5, the UE then may combine the per-cell CQM values from cell A 510 (e.g., at 572) and cell B 530 (e.g., at 574) through weighted averaging to derive the per-event CQM. On the other hand, the per-cell CQM value from cell C 550 (e.g., at 576) may not be used when deriving the per-event CQM, since it falls outside of the range defined by the best per-cell CQM (e.g., per-cell CQM for cell A 510 at 572) and the threshold 508. In some examples, the weight used in the weighted averaging process can be explicitly configured by the network. In some examples, the weights may be predefined values (e.g., values defined in a communication standard). In some examples, the weights may be determined by the UE.

In some aspects, the priority of the triggered event (e.g., the priority of the triggered event LTM2, LTM3, LTM4, or LTM5) may be determined based on various factors or a combination of one or more of these factors. These factors may include, for example, the per-event CQM, the best cell CQM (e.g., the best CQM among 572, 574, 576), the best beam CQM across cells (e.g., the best per-beam CQM at beam 518), the number of cells satisfying the threshold Z (e.g., two cells: cell A at 572 and cell B at 574), and the number of beams satisfying the threshold Y in each cell (e.g., two beams (beams 514, 518) for cell A 510, three beams (beams 532, 534, 538) for cell B 530, and four beams (beams 552, 554, 556, 558) for cell C 550). For example, the priority of the triggered event (e.g., the priority of the triggered event LTM2, LTM3, LTM4, or LTM5) may be determined based solely on the best per-event CQM, or based on the best cell-level CQM when no threshold Z (e.g., threshold 508) is applied. In some examples, when the prioritization of the triggered events is based on factors other than the value of the per-event CQM, the per-event CQM computation may be skipped. In some examples, when the prioritization of the triggered events is based on factors other than the value of the per-cell CQM, the per-cell CQM computation may be skipped.

In some aspects, a per-event CQM may be derived from per-cell CQM, which may be obtained from per-beam CQM. In some examples, the derivation of the per-event CQM may be based on the identification of good cells that have good beams with respect to the best beam showing the highest per-beam CQM value. Based on this, the priority of the triggered event (e.g., the priority of the triggered event LTM2, LTM3, LTM4, or LTM5) may be determined.

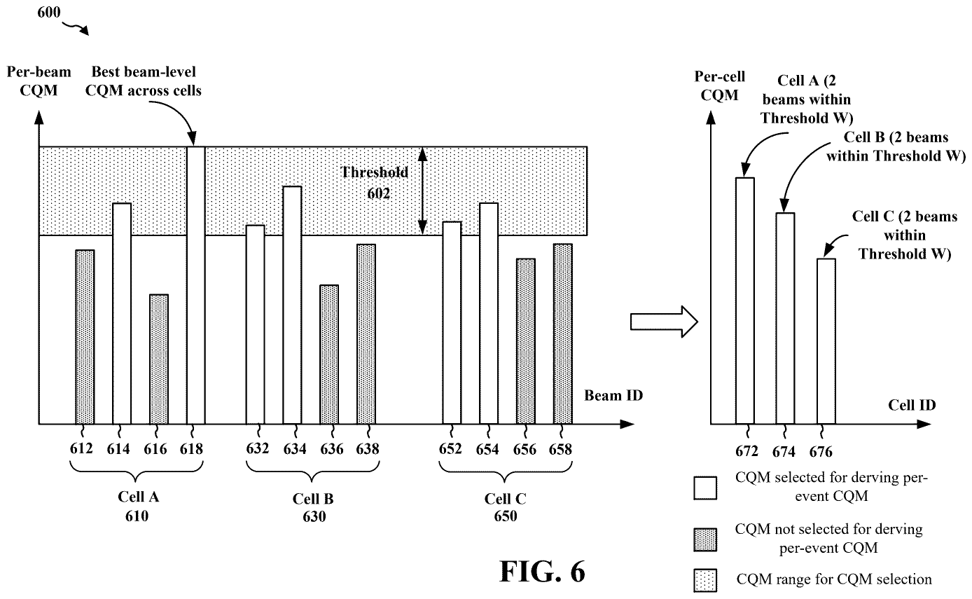

In this procedure, the UE may first identify the best beam with the highest per-beam CQM value and the cell to which this beam belongs. FIG. 6 is a diagram 600 illustrating a per-event CQM derivation method in accordance with various aspects of the present disclosure. As shown in FIG. 6, the UE may first identify the best beam (e.g., beam 618) with the highest per-beam CQM value and the cell (e.g., cell A 610) to which this beam (e.g., beam 618) belongs. In some examples, the UE may be configured with a threshold W (e.g., threshold 602), and the UE may identify the beams that have per-beam CQM values greater than or equal to the best per-beam CQM minus threshold W and identify their associated cells. For example, in FIG. 6, the UE may identify beam 614 and its associated cell (e.g., cell A 610), beams 632, 634 and their associated cell (e.g., cell B 630), and beams 652, 654 and their associated cell (e.g., cell C 650). The UE may identify these beams (e.g., beams 614, 632, 634, 652, 654) and their associated cells as these beams have their per-beam CQM values within the range defined by the best-beam CQM (e.g., at beam 618) and the threshold 602. On the other hand, the UE may not identify beams 612, 616, 636, 638, 656, and 658, as their per-beam CQM values fall outside of the range defined by the best-beam CQM (e.g., at beam 618) and the threshold 602. In some examples, the threshold W may not be configured for the UE or the threshold W may be set to zero. In these case, the best beam's CQM (e.g., CQM at beam 618) and the corresponding cell (e.g., cell A 610) are used to derive the per-event CQM.

For the cells that have the selected beams (e.g., cell A 610, cell B 630, cell C 650), the UE may combine the selected per-beam CQM values through weighted averaging to derive the per-cell CQM. In some examples, the weight used in the weighted averaging process can be explicitly configured by the network. In some examples, the weights may be predefined values (e.g., values defined in a communication standard). In some examples, the weights may be determined by the UE. For example, in FIG. 6, the UE may combine the selected per-beam CQM values from beams 614, 618 through weighted averaging to derive the per-cell CQM for cell A 610 (e.g., at 672). The UE may further combine the selected per-beam CQM values from beams 632, 634 through weighted averaging to derive the per-cell CQM for cell B 630 (e.g., at 674), and combine the selected per-beam CQM values from beams 652, 654 through weighted averaging to derive the per-cell CQM for cell C 650 (e.g., at 676).

The UE can then combine the per-cell CQM values (e.g., the per-cell CQM values at 672, 674, 676) through weighted averaging to derive the per-event CQM. In some examples, the weight used in the weighted averaging process can be explicitly configured by the network. In some examples, the weights may be predefined values (e.g., values defined in a communication standard). In some examples, the weights may be determined by the UE.

In some aspects, the priority of the triggered event (e.g., the priority of the triggered event LTM2, LTM3, LTM4, or LTM5) may be determined based on various factors or a combination of one or more of these factors. These factors may include, for example, the per-event CQM, the best cell CQM (e.g., the best CQM among 672, 674, 676), the number of cells satisfying the threshold W (e.g., three cells (cell A 610, cell B 630, cell C 650) in FIG. 6), the best beam CQM across selected cells (e.g., the best beam CQM for beam 618), and the number of beams satisfying the threshold W in the selected cells (e.g., two beams (beams 614, 618) for cell A 610). In some examples, the priority of the triggered event (e.g., the priority of the triggered event LTM2, LTM3, LTM4, or LTM5) may be determined based solely on the best per-event CQM. In some examples, the priority of the triggered event (e.g., the priority of the triggered event LTM2, LTM3, LTM4, or LTM5) may be determined based on the best beam-level CQM (e.g., best CQM at beam 618) when no threshold W (e.g., threshold 602) is applied. In this case, the event-level CQM can be equivalent to the best beam-level CQM. In some examples, the priority of the triggered event (e.g., the priority of the triggered event LTM2, LTM3, LTM4, or LTM5) may be determined based only on the cell with the maximum number of beams satisfying the threshold W (e.g., threshold 602). In some examples, the priority of the triggered event (e.g., the priority of the triggered event LTM2, LTM3, LTM4, or LTM5) may be determined based on the number of cells (e.g., three cells (cell A 610, cell B 630, cell C 650) in FIG. 6) that have beams satisfying the threshold W (e.g., threshold 602). In some examples, when the prioritization of the triggered events is based on factors other than the value of the per-event CQM, the per-event CQM computation may be skipped. In some examples, when the prioritization of the triggered events is based on factors other than the value of the per-cell CQM, the per-cell CQM computation may be skipped.

In some aspects, the selection of the beams used for determining the per-event CQM may be based on the beam priority associated with each beam. In some examples, the beam priority may be based on TCI activation and/or early TA acquisition associated with the beam.

In some examples, when a beam is considered for per-beam CQM derivation (which may be used to determine the priority of triggered events) or for the report metric to be included in the measurement report, the priority of the beam may be based on whether the beam has been used for TCI state activation and/or early uplink TA acquisition. For CQM derivation, beams for which TCI state activation and/or early TA have been performed, and are valid, may be given higher priority compared to beams for which neither condition applies. Similarly, cells that have beams with activated TCI state and/or early TA performed, and valid, may have higher priority than cells without any such applicable beams.

In some aspects, for report content, beams that have undergone TCI state activation and/or early TA acquisition, whether the early TA is valid or invalid, may be assigned higher priority than beams without these conditions. As a result, such beams may be included in the measurement report even if they did not trigger the event or if their report metric is lower than that of other beams. If these beams did not trigger the event, they may still be given lower priority than the beams that actually triggered the event, and their inclusion in the report may depend on whether there is remaining payload available after adding the information of the beams and their measurements that triggered the event.

In some aspects, a threshold V may be configured for the UE to control whether these beams are included, so that these beams are added if their report metric is greater than or equal to the highest report metric for the event or the cell minus threshold V (i.e., their report metric is within a range defined by the highest report metric and the threshold V). In some aspects, when selecting the beams for the CQM derivation or for reporting, the beams may be exclusively selected from beams with “high priority.” In some aspects, when selecting the beams for the CQM derivation or for reporting, the beams with “high priority” may be given higher weights compared to the beams with “low priority.” In some examples, beams with valid TA may have a higher priority over beams with invalid TA. In some examples, the prioritization operation or rule may be configured by the network through RRC configuration.

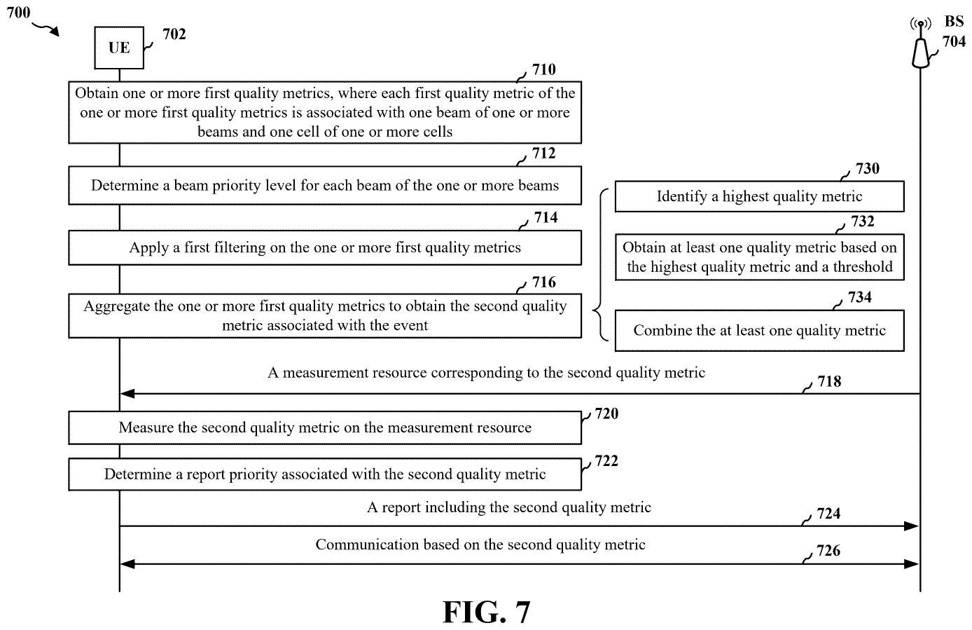

FIG. 7 is a call flow diagram 700 illustrating a method of wireless communication in accordance with various aspects of this present disclosure. Various aspects are described in connection with a UE 702 and a base station 704. The aspects may be performed by the UE 702 or the base station 704 in aggregation and/or by one or more components of a base station 704 (e.g., a CU 110, a DU 130, and/or an RU 140).

As shown in FIG. 7, at 710, the UE 702 may obtain one or more first quality metrics. Each first quality metric of the one or more first quality metrics may be associated with one beam of one or more beams and one cell of one or more cells. For example, the first quality metric may include L1-RSRP, L1-SINR, or L1-RSRQ associated with one beam and one cell. In some examples, the UE 702 may obtain the one or more first quality metrics based on actual measurement results on the first quality metrics. In some examples, the UE 702 may obtain the one or more first quality metrics based on a prediction or inference result from a model, such as an AI/ML model.

At 712, the UE 702 may determine a beam priority level for each beam of the one or more beams. In some examples, the beam priority level may be determined based on one or more of: the TCI state activation of the beam, or an early uplink TA acquisition of the beam. For example, beams for which TCI state activation and/or early TA have been performed, and are valid, may be given higher priority compared to beams for which neither condition applies.

At 714, the UE 702 may apply a first filtering on the one or more first quality metrics in a cell aggregation of the one or more first quality metrics across the one or more cells.

At 716, the UE 702 may aggregate the one or more first quality metrics to obtain the second quality metric associated with the event. For example, referring to FIG. 4, the UE may aggregate the one or more first quality metrics respectively on one or more beams (e.g., beams 402, 404, 406, 408) to obtain the second quality metric associated with the event.

In some aspects, to aggregate one or more first quality metrics, the UE may first identify the highest quality metric (e.g., at 730). For example, the highest quality metric may be the highest per-beam quality metric among the one or more per-beam quality metrics, the highest first quality metric among the one or more first quality metrics within a cell, or the highest per-cell quality metric among the one or more per-cell quality metrics. Then, the UE may obtain at least one quality metric based on the highest quality metric and a threshold (e.g., at 732). For example, the UE 702 may obtain at least one quality metric if this quality metric falls within a range defined by the highest quality metric and the threshold. The UE 702 may combine the at least one quality metric to obtain the second quality metric (e.g., at 734).

In some examples, the second quality metric may have a metric type that is different from that of the first quality metric. For example, the second quality metric may be L1-RSRP, while the first quality metric may be L1-SINR. In that case, at 718, the UE 702 may receive a measurement resource from base station 704 corresponding to the second quality metric.

At 720, the UE 702 may measure the second quality metric on the measurement resource based on the aggregation of the one or more per-beam quality metrics. For example, the UE 702 may measure the second quality on a selected cell or a selected beam based on the aggregation of the one or more per-beam quality metrics.

At 722, the UE 702 may determine a report priority associated with the second quality metric. For example, the report priority may be based on one or more of: the second quality metric, the highest quality metric (e.g., the highest per-beam quality metric), or the number of quality metrics (e.g., per-beam quality metrics) used to obtain the second quality metric.

At 724, the UE 702 may report, to base station 704, the second quality metric associated with the event.

At 726, the UE 702 may communicate with base station 704 based on a second quality metric associated with an event. For example, the UE may obtain the second quality metric based on an aggregation of the one or more first quality metrics (e.g., at 716). For example, the second quality metric may trigger an event (e.g., LTM2, LTM3, LTM4, or LTM5). Based on the triggered event, the UE 702 may perform an LTM or conditional LTM, for example.

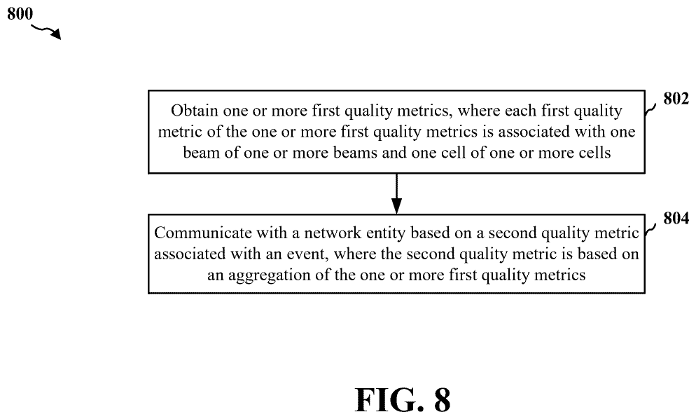

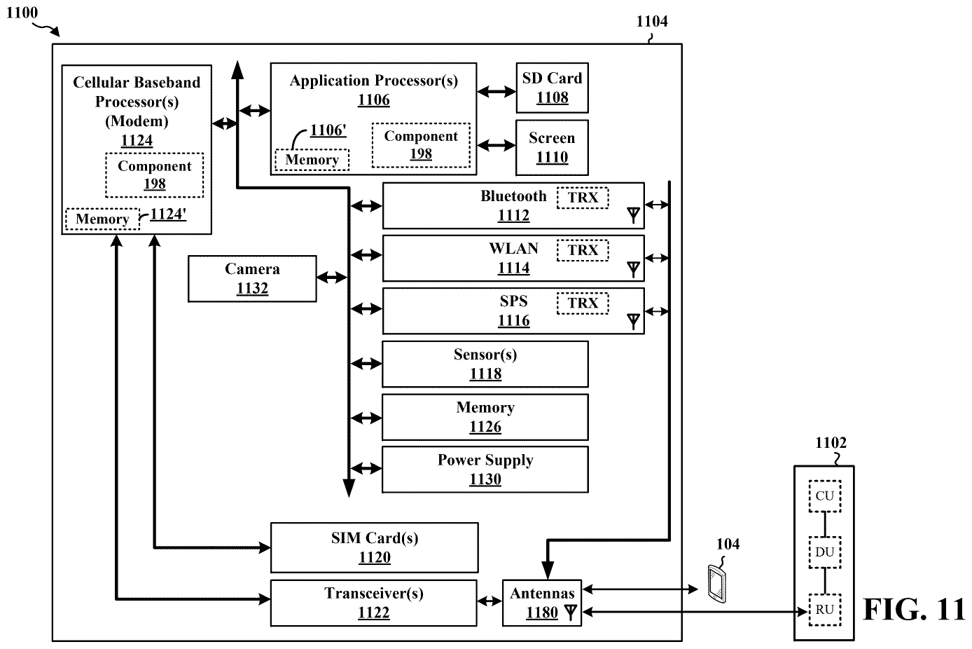

FIG. 8 is a flowchart 800 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 704; or the network entity 1102 in the hardware implementation of FIG. 11). The UE may be the UE 104, 350, 702, or the apparatus 1104 in the hardware implementation of FIG. 11. By introducing per-event CQM for event-triggered L1 measurement reports in LTM and computing the per-event CQM from multiple beams instead of reporting the best instantaneous measurement, the methods improve the reliability of mobility events and reduce the impact of noisy or fluctuating L1 measurements. Additionally, by introducing configurable thresholds for selecting multiple strong beams and cells, the methods can be adapted to various network conditions and configurations, thereby improving the adaptability and robustness of measurements. In some examples, by incorporating beam and cell prioritization based on prior TCI state activation and/or early TA acquisition, the methods ensure that resources already optimized for fast switching are given higher priority, thereby enhancing the efficiency of LTM procedures.

As shown in FIG. 8, at 802, the UE may obtain one or more first quality metrics. Each first quality metric of the one or more first quality metrics may be associated with one beam of one or more beams and one cell of one or more cells. FIG. 4, FIG. 5, FIG. 6, and FIG. 7 illustrate various aspects of the steps in connection with flowchart 800. For example, referring to FIG. 7, the UE 702 may obtain one or more first quality metrics at 710. Referring to FIG. 4 and FIG. 5, each first quality metric of the one or more first quality metrics may be associated with one beam (e.g., beam 402, 404, 406, 408) of one or more beams and one cell of one or more cells (e.g., cell A 510, cell B 530, cell C 550). In some aspects, 802 may be performed by the measurement component 198.

At 804, the UE may communicate with a network entity based on a second quality metric associated with an event. The second quality metric is based on an aggregation of the one or more first quality metrics. For example, referring to FIG. 7, the UE 702 may, at 726, communicate with a network entity (e.g., base station 704) based on a second quality metric associated with an event. For example, the second quality metric may be a per-event CQM, which is based on an aggregation of the one or more first quality metrics (e.g., per-beam CQM). In some aspects, 804 may be performed by the measurement component 198.

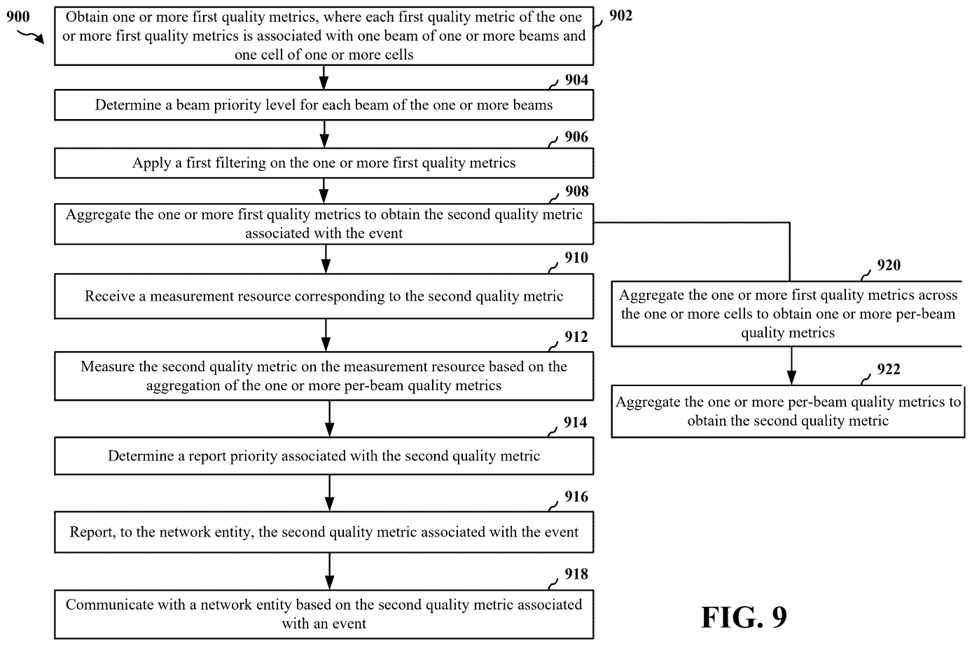

FIG. 9 is a flowchart 900 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 704; or the network entity 1102 in the hardware implementation of FIG. 11). The UE may be the UE 104, 350, 702, or the apparatus 1104 in the hardware implementation of FIG. 11. By introducing per-event CQM for event-triggered L1 measurement reports in LTM and computing the per-event CQM from multiple beams instead of reporting the best instantaneous measurement, the methods improve the reliability of mobility events and reduce the impact of noisy or fluctuating L1 measurements. Additionally, by introducing configurable thresholds for selecting multiple strong beams and cells, the methods can be adapted to various network conditions and configurations, thereby improving the adaptability and robustness of measurements. In some examples, by incorporating beam and cell prioritization based on prior TCI state activation and/or early TA acquisition, the methods ensure that resources already optimized for fast switching are given higher priority, thereby enhancing the efficiency of LTM procedures.

As shown in FIG. 9, at 902, the UE may obtain one or more first quality metrics. Each first quality metric of the one or more first quality metrics may be associated with one beam of one or more beams and one cell of one or more cells. FIG. 4, FIG. 5, FIG. 6, and FIG. 7 illustrate various aspects of the steps in connection with flowchart 900. For example, referring to FIG. 7, the UE 702 may obtain one or more first quality metrics at 710. Referring to FIG. 4 and FIG. 5, each first quality metric of the one or more first quality metrics may be associated with one beam (e.g., beam 402, 404, 406, 408) of one or more beams and one cell of one or more cells (e.g., cell A 510, cell B 530, cell C 550). In some aspects, 902 may be performed by the measurement component 198.

At 918, the UE may communicate with a network entity based on a second quality metric associated with an event. The second quality metric is based on an aggregation of the one or more first quality metrics. For example, referring to FIG. 7, the UE 702 may, at 726, communicate with a network entity (e.g., base station 704) based on a second quality metric associated with an event. For example, the second quality metric may be a per-event CQM, which is based on an aggregation of the one or more first quality metrics (e.g., per-beam CQM). In some aspects, 918 may be performed by the measurement component 198.

In some aspects, at 916, the UE may report, to the network entity, the second quality metric associated with the event. For example, referring to FIG. 7, the UE 702 may, at 724, report, to the network entity (e.g., base station 704), the second quality metric associated with the event. In some aspects, 916 may be performed by the measurement component 198.

In some aspects, at 908, the UE may aggregate the one or more first quality metrics to obtain the second quality metric associated with the event. For example, referring to FIG. 7, the UE 702 may, at 716, aggregate the one or more first quality metrics to obtain the second quality metric associated with the event. Referring to FIG. 5, the UE may aggregate the one or more first quality metrics (e.g., the per-beam CQM at beams 514, 518, 532, 534, 538, 552, 554, 556, 558) to obtain the second quality metric (e.g., the per-event CQM) associated with the event. In some aspects, 908 may be performed by the measurement component 198.

In some aspects, to aggregate the one or more first quality metrics to obtain the second quality metric associated with the event (e.g., at 908), the UE may, at 920, aggregate the one or more first quality metrics across the one or more cells to obtain one or more per-beam quality metrics. Each per-beam quality metric of the one or more per-beam quality metrics may correspond to one beam of the one or more beams. The UE may further aggregate the one or more per-beam quality metrics to obtain the second quality metric (e.g., at 922). For example, referring to FIG. 7, the UE 702 may, at 720, aggregate the one or more first quality metrics across the one or more cells to obtain one or more per-beam quality metrics. Each per-beam quality metric of the one or more per-beam quality metrics may correspond to one beam of the one or more beams. Referring to FIG. 4, the UE may further aggregate the one or more per-beam quality metrics (e.g., CQM at beam 402, 404, 406, 408) to obtain the second quality metric. In some aspects, 920 and 922 may be performed by the measurement component 198.

In some aspects, at 906, the UE may apply a first filtering on the one or more first quality metrics in a cell aggregation of the one or more first quality metrics across the one or more cells. For example, referring to FIG. 7, the UE 702 may, at 714, apply a first filtering on the one or more first quality metrics in a cell aggregation of the one or more first quality metrics across the one or more cells. In some aspects, 906 may be performed by the measurement component 198.

In some aspects, the UE may, at 904, determine the beam priority level for each beam of the one or more beams. For example, the beam priority level may be based on one or more of: the TCI state activation of the beam, or an early uplink TA acquisition of the beam. For example, referring to FIG. 7, the UE 702 may, at 712, determine the beam priority level for each beam of the one or more beams. For example, the beam priority level may be based on one or more of: the TCI state activation of the beam, or an early uplink TA acquisition of the beam. For example, beams for which TCI state activation and/or early TA have been performed, and are valid, may be given higher priority compared to beams for which neither condition applies. In some aspects, 904 may be performed by the measurement component 198.

In some aspects, to aggregate the one or more per-beam quality metrics to obtain the second quality metric (e.g., at 922), the UE may aggregate, based on the beam priority level for each beam of the one or more beams (e.g., at 904), the one or more per-beam quality metrics to obtain the second quality metric. For example, referring to FIG. 4, the UE 702 may aggregate, based on the beam priority level for each beam of the one or more beams (e.g., beam 402, 404, 406, 408, 412, 414), the one or more per-beam quality metrics to obtain the second quality metric.

In some aspects, the first quality metric may be a first metric type, and the second quality metric is a second metric type different from the first metric type. And at 910, the UE may receive a measurement resource corresponding to the second quality metric, and, at 912, measure the second quality metric on the measurement resource based on the aggregation of the one or more per-beam quality metrics. For example, referring to FIG. 7, when the first quality metric and the second quality metric are of different metric types (e.g., when the first quality metric is L1-RSRP, and the second quality metric is L1-SINR), the UE may, at 718, receive a measurement resource corresponding to the second quality metric, and, at 720, measure the second quality metric on the measurement resource based on the aggregation of the one or more per-beam quality metrics. For example, the UE 702 may measure the second quality on a selected cell or a selected beam, and the selected beam or the selected cell is based on the aggregation of the one or more per-beam quality metrics. In some aspects, 910 and 912 may be performed by the measurement component 198.

In some aspects, each first quality metric of the one or more first quality metrics may be obtained based on one or more of: a measurement result on the UE, or a prediction or inference result from an AI/ML model. For example, referring to FIG. 7, each first quality metric of the one or more first quality metrics (e.g., at 710), such as L1-RSRP or L1-SINR, may be obtained based on one or more of: a measurement result on the UE 702, or a prediction or inference result from an AI/ML model.

In some aspects, to aggregate the one or more per-beam quality metrics to obtain the second quality metric (e.g., at 922), the UE may identify the highest per-beam quality metric among the one or more per-beam quality metrics; obtain at least one per-beam quality metric from the one or more per-beam quality metrics based on a first threshold range to the highest per-beam quality metric; and combine the at least one per-beam quality metric to obtain the second quality metric. For example, referring to FIG. 4, the UE may identify the highest per-beam quality metric (e.g., the highest CQM at beam 402) among the one or more per-beam quality metrics (e.g., CQM at beams 402, 404, 406, 408, 412, 414); obtain at least one per-beam quality metric (e.g., CQM at beams 402, 404, 406, 408) from the one or more per-beam quality metrics based on a first threshold range (e.g., first threshold 410) to the highest per-beam quality metric (e.g., the highest CQM at beam 402); and combine the at least one per-beam quality metric (e.g., CQM at beams 402, 404, 406, 408) to obtain the second quality metric.

In some aspects, to aggregate the one or more per-beam quality metrics to obtain the second quality metric (e.g., at 922), the UE may identify the highest-beam cell in the one or more cells, and the highest-beam cell is associated with the highest per-beam quality metric; and obtain at least one candidate quality metric from the one or more first quality metric and at least one candidate cell from the one or more cells. The at least one candidate quality metric may be within a cell threshold range of the highest per-beam quality metric, and where the at least one candidate cell is associated with the at least one candidate quality metric. For example, referring to FIG. 6, the UE may identify the highest-beam cell (e.g., cell A 610) in the one or more cells, and the highest-beam cell is associated with the highest per-beam quality metric (e.g., CQM at beam 618); and obtain at least one candidate quality metric (e.g., CQM at beams 614, 632, 634, 652, 654) from the one or more first quality metric and at least one candidate cell (e.g., cell A 610, cell B 630, cell C 650) from the one or more cells. The at least one candidate quality metric may be within a cell threshold range (e.g., threshold 602) of the highest per-beam quality metric, and the at least one candidate cell is associated with the at least one candidate quality metric.

In some aspects, to combine the at least one per-beam quality metric to obtain the second quality metric, the UE may aggregate the at least one candidate quality metric across the at least one candidate cell to obtain one or more per-cell quality metrics, where each per-cell quality metric of the one or more per-cell quality metrics corresponds to one candidate cell of the at least one candidate cell; and aggregate the one or more per-cell quality metrics to obtain the second quality metric. For example, referring to FIG. 5, the UE may aggregate the at least one candidate quality metric (e.g., CQM at beams 514, 518) across the at least one candidate cell (e.g., cell A 510) to obtain one or more per-cell quality metrics (e.g., CQM at 572). Each per-cell quality metric (e.g., CQM at 572, 574, 576) of the one or more per-cell quality metrics corresponds to one candidate cell (e.g., CQM at 572 corresponds to cell A 510, CQM at 574 corresponds to cell B 530, CQM at 576 corresponds to cell C 550) of the at least one candidate cell; and aggregate the one or more per-cell quality metrics to obtain the second quality metric.

In some aspects, to combine the at least one per-beam quality metric to obtain the second quality metric, the UE may perform, based on beam weights respectively associated with the at least one per-beam quality metric, a weighted averaging on the at least one per-beam quality metric to obtain the second quality metric. For example, referring to FIG. 4, the UE may perform, based on beam weights respectively associated with the at least one per-beam quality metric (e.g., CQM at beams 402, 404, 406, 408), a weighted averaging on the at least one per-beam quality metric to obtain the second quality metric.

In some aspects, the beam weights respectively associated with the at least one per-beam quality metric may be based on one or more of: a weight configuration from the network entity, predefined values, or an implementation on the UE. For example, referring to FIG. 7, the beam weights respectively associated with the at least one per-beam quality metric may be based on one or more of: a weight configuration from the network entity (e.g., base station 704), predefined values, or an implementation on the UE 702.

In some aspects, at 914, the UE may determine a report priority associated with the second quality metric. The report priority may be based on one or more of: the second quality metric, the highest per-beam quality metric, or the number of per-beam quality metrics in the at least one per-beam quality metric within the first threshold range of the highest per-beam quality metric. For example, referring to FIG. 7, the UE 702 may, at 722, determine a report priority associated with the second quality metric. The report priority may be based on one or more of: the second quality metric, the highest per-beam quality metric (e.g., the highest CQM at beam 402), or the number of per-beam quality metrics (e.g., four CQM corresponding to beams 402, 404, 406, 408) in the at least one per-beam quality metric within the first threshold range (e.g., first threshold 410) of the highest per-beam quality metric. In some aspects, 914 may be performed by the measurement component 198.

In some aspects, to aggregate the one or more first quality metrics to obtain the second quality metric associated with the event (e.g., at 908), the UE may aggregate the one or more first quality metrics across the one or more beams to obtain one or more per-cell quality metrics, where each per-cell quality metric of the one or more per-cell quality metrics corresponds to one cell of the one or more cells; and aggregate the one or more per-cell quality metrics to obtain the second quality metric. For example, referring to FIG. 5, the UE may aggregate the one or more first quality metrics (e.g., CQM at beam 514, 518 for cell A 510) across the one or more beams to obtain one or more per-cell quality metrics (e.g., CQM for cell A 510 at 572), where each per-cell quality metric of the one or more per-cell quality metrics corresponds to one cell of the one or more cells; and aggregate the one or more per-cell quality metrics (e.g., CQM at 572, 574) to obtain the second quality metric.

In some aspects, to aggregate the one or more first quality metrics across the one or more beams to obtain the one or more per-cell quality metric, the UE may identify, for each cell of the one or more cells, the highest first quality metric among the one or more first quality metrics for the cell; obtain, for each cell of the one or more cells, at least one first quality metric from the one or more first quality metric based on a second threshold range to the highest first quality metric; and combine, for each cell of the one or more cells, the at least one first quality metric to obtain the one or more per-cell quality metric. For example, referring to FIG. 5, for cell A 510, the UE may identify the highest first quality metric (e.g., CQM at beam 518) among the one or more first quality metrics for the cell (e.g., cell A 510); obtain at least one first quality metric (e.g., CQM at beam 514) from the one or more first quality metric based on a second threshold range (e.g., threshold 502) to the highest first quality metric; and combine the at least one first quality metric (e.g., CQM at beam 514, 518) to obtain the one or more per-cell quality metric (e.g., CQM for cell A 510 at 572).

In some aspects, to aggregate the one or more per-cell quality metrics to obtain the second quality metric, the UE may identify the highest per-cell quality metrics among the one or more per-cell quality metrics; obtain at least one per-cell quality metric from the one or more per-cell quality metrics based on a third threshold range to the highest per-cell quality metric; and combine the at least one per-cell quality metric to obtain the second quality metric. For example, referring to FIG. 5, to aggregate the one or more per-cell quality metrics to obtain the second quality metric, the UE may identify the highest per-cell quality metrics (e.g., highest CQM at 572) among the one or more per-cell quality metrics; obtain at least one per-cell quality metric (e.g., CQM at 572, 574) from the one or more per-cell quality metrics based on a third threshold range (e.g., threshold 508) to the highest per-cell quality metric; and combine the at least one per-cell quality metric (e.g., CQM at 572, 574) to obtain the second quality metric.

In some aspects, to combine the at least one per-cell quality metric to obtain the second quality metric, the UE may perform, based on cell weights respectively associated with the at least one per-cell quality metric, a weighted averaging on the at least one per-cell quality metric to obtain the second quality metric. For example, referring to FIG. 5, the UE may perform, based on cell weights respectively associated with the at least one per-cell quality metric, a weighted averaging on the at least one per-cell quality metric (e.g., CQM at 572, 574) to obtain the second quality metric.

In some aspects, the UE may, at 914, determine a report priority associated with the second quality metric. The report priority may be based on one or more of: the second quality metric, the highest per-cell quality metric, or a number of per-cell quality metrics in the at least one per-cell quality metric within the second threshold range to the highest per-cell quality metric. For example, referring to FIG. 5, the UE may determine a report priority associated with the second quality metric. The report priority may be based on one or more of: the second quality metric, the highest per-cell quality metric (e.g., highest CQM at 572), or a number of per-cell quality metrics (e.g., two CQM at 572, 574) in the at least one per-cell quality metric within the second threshold range (e.g., threshold 508) to the highest per-cell quality metric (e.g., CQM at 572).

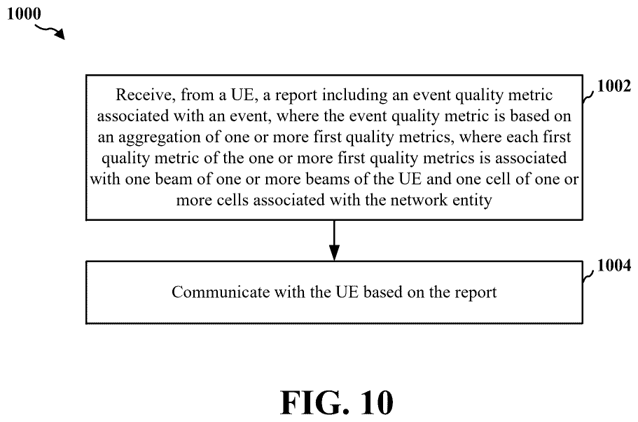

FIG. 10 is a flowchart 1000 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 704; or the network entity 1102 in the hardware implementation of FIG. 11). The UE may be the UE 104, 350, 702, or the apparatus 1104 in the hardware implementation of FIG. 11. By introducing per-event CQM for event-triggered L1 measurement reports in LTM and computing the per-event CQM from multiple beams instead of reporting the best instantaneous measurement, the methods improve the reliability of mobility events and reduce the impact of noisy or fluctuating L1 measurements. Additionally, by introducing configurable thresholds for selecting multiple strong beams and cells, the methods can be adapted to various network conditions and configurations, thereby improving the adaptability and robustness of measurements. In some examples, by incorporating beam and cell prioritization based on prior TCI state activation and/or early TA acquisition, the methods ensure that resources already optimized for fast switching are given higher priority, thereby enhancing the efficiency of LTM procedures.

As shown in FIG. 10, at 1002, the network entity may receive, from a UE, a report including an event quality metric associated with an event. The event quality metric is based on an aggregation of one or more first quality metrics, and each first quality metric of the one or more first quality metrics is associated with one beam of one or more beams of the UE and one cell of one or more cells associated with the network entity. FIG. 4, FIG. 5, FIG. 6, and FIG. 7 illustrate various aspects of the steps in connection with flowchart 1000. For example, referring to FIG. 7, the network entity (e.g., base station 704) may, at 724, receive, from UE 702, a report including an event quality metric associated with an event. The event quality metric is based on an aggregation of one or more first quality metrics, and each first quality metric of the one or more first quality metrics is associated with one beam of one or more beams of the UE 702 and one cell of one or more cells associated with the network entity (e.g., base station 704). In some aspects, 1002 may be performed by the measurement component 199.

At 1004, the network entity may communicate with the UE based on the report. For example, referring to FIG. 7, the network entity (e.g., base station 704) may, at 726, communicate with the UE 702 based on the report. In some aspects, 1004 may be performed by the measurement component 199.

In some aspects, the first quality metric is a first metric type, and the second quality metric is a second metric type different from the first metric type. The network entity may configure, for the UE, a measurement resource corresponding to the second quality metric. For example, referring to FIG. 7, when the first quality metric and the second quality metric are of different metric type (e.g., when the first quality metric is L1-RSRP, and the second quality metric is L1-SINR), the network entity (e.g., base station 704) may, at 718, configure a measurement resource corresponding to the second quality metric for the UE 702.

In some aspects, each first quality metric of the one or more first quality metrics may be obtained based on one or more of: a measurement result on the UE, or a prediction or inference result from an AI/ML model. For example, referring to FIG. 7, each first quality metric of the one or more first quality metrics (e.g., at 710), such as L1-RSRP or L1-SINR, may be obtained based on one or more of: a measurement result on the UE 702, or a prediction or inference result from an AI/ML model.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor (or processing circuitry) 1124 (also referred to as a modem) coupled to one or more transceivers 1122 (e.g., cellular RF transceiver). The cellular baseband processor(s) (or processing circuitry) 1124 may include at least one on-chip memory (or memory circuitry) 1124′. In some aspects, the apparatus 1104 may further include one or more subscriber identity modules (SIM) cards 1120 and at least one application processor (or processing circuitry) 1106 coupled to a secure digital (SD) card 1108 and a screen 1110. The application processor(s) (or processing circuitry) 1106 may include on-chip memory (or memory circuitry) 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) (or processing circuitry) 1124 communicates through the transceiver(s) 1122 via one or more antennas 1180 with the UE 104 and/or with an RU associated with a network entity 1102. The cellular baseband processor(s) (or processing circuitry) 1124 and the application processor(s) (or processing circuitry) 1106 may each include a computer-readable medium/memory (or memory circuitry) 1124′, 1106′, respectively. The additional memory modules 1126 may also be considered a computer-readable medium/memory (or memory circuitry). Each computer-readable medium/memory (or memory circuitry) 1124′, 1106′, 1126 may be non-transitory. The cellular baseband processor(s) (or processing circuitry) 1124 and the application processor(s) (or processing circuitry) 1106 are each responsible for general processing, including the execution of software stored on the computer-readable medium/memory (or memory circuitry). The software, when executed by the cellular baseband processor(s) (or processing circuitry) 1124/application processor(s) (or processing circuitry) 1106, causes the cellular baseband processor(s) (or processing circuitry) 1124/application processor(s) (or processing circuitry) 1106 to perform the various functions described supra. The cellular baseband processor(s) (or processing circuitry) 1124 and the application processor(s) (or processing circuitry) 1106 are configured to perform the various functions described supra based at least in part of the information stored in the memory (or memory circuitry). That is, the cellular baseband processor(s) (or processing circuitry) 1124 and the application processor(s) (or processing circuitry) 1106 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1124/application processor(s) (or processing circuitry) 1106 when executing software. The cellular baseband processor(s) (or processing circuitry) 1124/application processor(s) (or processing circuitry) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) (or processing circuitry) 1124 and/or the application processor(s) (or processing circuitry) 1106, and in another configuration, the apparatus 1104 may be the entire UE (e.g., see UE 350 of FIG. 3) and include the additional modules of the apparatus 1104.

As discussed supra, the component 198 may be configured to obtain one or more first quality metrics, where each first quality metric of the one or more first quality metrics is associated with one beam of one or more beams and one cell of one or more cells; and communicate with a network entity based on a second quality metric associated with an event, where the second quality metric is based on an aggregation of the one or more first quality metrics. The component 198 may be further configured to perform any of the aspects described in connection with the flowcharts in FIG. 8 and FIG. 9, and/or performed by the UE 702 in FIG. 7. The component 198 may be within the cellular baseband processor(s) (or processing circuitry) 1124, the application processor(s) (or processing circuitry) 1106, or both the cellular baseband processor(s) (or processing circuitry) 1124 and the application processor(s) (or processing circuitry) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) (or processing circuitry) 1124 and/or the application processor(s) (or processing circuitry) 1106, includes means for obtaining one or more first quality metrics, where each first quality metric of the one or more first quality metrics is associated with one beam of one or more beams and one cell of one or more cells; and means for communicating with a network entity based on a second quality metric associated with an event. The second quality metric is based on an aggregation of the one or more first quality metrics. The apparatus 1104 may further include means for performing any of the aspects described in connection with the flowcharts in FIG. 8 and FIG. 9, and/or aspects performed by the UE 702 in FIG. 7. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

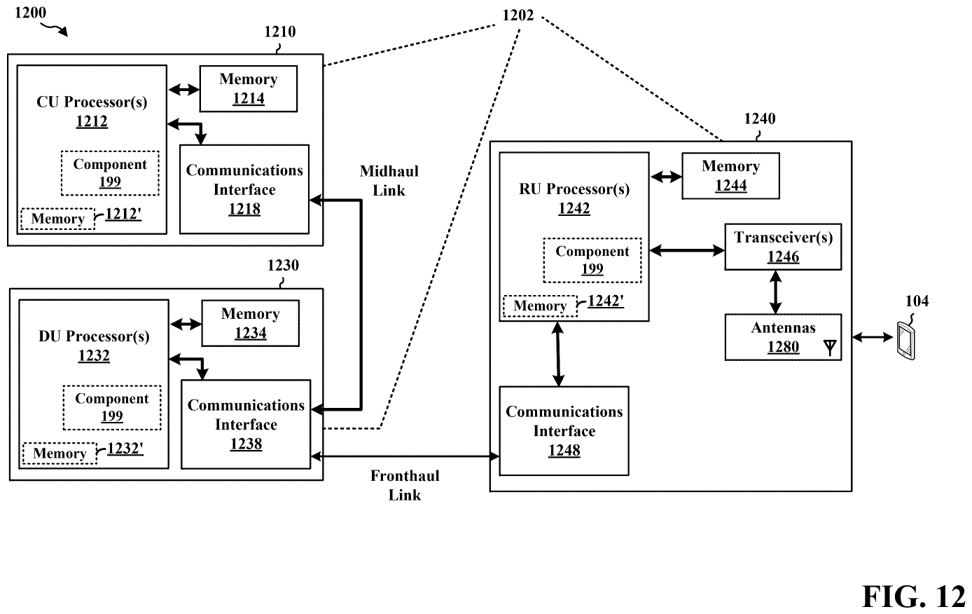

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor (or processing circuitry) 1212. The CU processor(s) (or processing circuitry) 1212 may include on-chip memory (or memory circuitry) 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor (or processing circuitry) 1232. The DU processor(s) (or processing circuitry) 1232 may include on-chip memory (or memory circuitry) 1232′. In some aspects, the DU 1230 may further include additional memory modules 1234 and a communications interface 1238. The DU 1230 communicates with the RU 1240 through a fronthaul link. The RU 1240 may include at least one RU processor (or processing circuitry) 1242. The RU processor(s) (or processing circuitry) 1242 may include on-chip memory (or memory circuitry) 1242′. In some aspects, the RU 1240 may further include additional memory modules 1244, one or more transceivers 1246, antennas 1280, and a communications interface 1248. The RU 1240 communicates with the UE 104. The on-chip memory (or memory circuitry) 1212′, 1232′, 1242′ and the additional memory modules 1214, 1234, 1244 may each be considered a computer-readable medium/memory (or memory circuitry). Each computer-readable medium/memory (or memory circuitry) may be non-transitory. Each of the processors (or processing circuitry) 1212, 1232, 1242 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to receive, from a UE, a report including an event quality metric associated with an event, where the event quality metric is based on an aggregation of one or more first quality metrics, where each first quality metric of the one or more first quality metrics is associated with one beam of one or more beams of the UE and one cell of one or more cells associated with the network entity; and communicate with the UE based on the report. The component 199 may be further configured to perform any of the aspects described in connection with the flowchart in FIG. 10, and/or performed by the base station 704 in FIG. 7. The component 199 may be within one or more processors (or processing circuitry) of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 includes means for receiving, from a UE, a report including an event quality metric associated with an event, where the event quality metric is based on an aggregation of one or more first quality metrics, where each first quality metric of the one or more first quality metrics is associated with one beam of one or more beams of the UE and one cell of one or more cells associated with the network entity; and means for communicating with the UE based on the report. The network entity 1202 may further include means for performing any of the aspects described in connection with the flowchart in FIG. 10, and/or aspects performed by the base station 704 in FIG. 7. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include obtaining one or more first quality metrics, where each first quality metric of the one or more first quality metrics is associated with one beam of one or more beams and one cell of one or more cells; and communicating with a network entity based on a second quality metric associated with an event, where the second quality metric is based on an aggregation of the one or more first quality metrics. By introducing per-event CQM for event-triggered L1 measurement reports in LTM and computing the per-event CQM from multiple beams instead of reporting the best instantaneous measurement, the methods improve the reliability of mobility events and reduce the impact of noisy or fluctuating L1 measurements. Additionally, by introducing configurable thresholds for selecting multiple strong beams and cells, the methods can be adapted to various network conditions and configurations, thereby improving the adaptability and robustness of measurements. In some examples, by incorporating beam and cell prioritization based on prior TCI state activation and/or early TA acquisition, the methods ensure that resources already optimized for fast switching are given higher priority, thereby enhancing the efficiency of LTM procedures.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE). The method includes obtaining one or more first quality metrics, wherein each first quality metric of the one or more first quality metrics is associated with one beam of one or more beams and one cell of one or more cells; and communicating with a network entity based on a second quality metric associated with an event, wherein the second quality metric is based on an aggregation of the one or more first quality metrics.

Aspect 2 is the method of aspect 1, wherein the method further includes reporting, to the network entity, the second quality metric associated with the event.

Aspect 3 is the method of any of aspects 1 to 2, wherein the method further includes aggregating the one or more first quality metrics to obtain the second quality metric associated with the event.

Aspect 4 is the method of aspect 3, wherein aggregating the one or more first quality metrics to obtain the second quality metric associated with the event comprises aggregating the one or more first quality metrics across the one or more cells to obtain one or more per-beam quality metrics, wherein each per-beam quality metric of the one or more per-beam quality metrics corresponds to one beam of the one or more beams; and aggregating the one or more per-beam quality metrics to obtain the second quality metric.

Aspect 5 is the method of aspect 4, wherein the method further includes applying a first filtering on the one or more first quality metrics in a cell aggregation of the one or more first quality metrics across the one or more cells.

Aspect 6 is the method of aspect 4, wherein the method further includes determining a beam priority level for each beam of the one or more beams, wherein the beam priority level is based on one or more of a transmission configuration indicator (TCI) state activation of the beam or an early uplink timing advance acquisition of the beam.

Aspect 7 is the method of aspect 6, wherein aggregating the one or more per-beam quality metrics to obtain the second quality metric comprises aggregating, based on the beam priority level for each beam of the one or more beams, the one or more per-beam quality metrics to obtain the second quality metric.

Aspect 8 is the method of aspect 4, wherein the first quality metric is a first metric type and the second quality metric is a second metric type different from the first metric type, and wherein the method further comprises receiving a measurement resource corresponding to the second quality metric; and measuring the second quality metric on the measurement resource based on the aggregation of the one or more per-beam quality metrics.

Aspect 9 is the method of aspect 4, wherein each first quality metric of the one or more first quality metrics is obtained based on one or more of a measurement result on the UE or a prediction or inference result from an artificial intelligence/machine learning (AI/ML) model.

Aspect 10 is the method of aspect 4, wherein aggregating the one or more per-beam quality metrics to obtain the second quality metric comprises identifying a highest per-beam quality metric among the one or more per-beam quality metrics; obtaining at least one per-beam quality metric from the one or more per-beam quality metrics based on a first threshold range to the highest per-beam quality metric; and combining the at least one per-beam quality metric to obtain the second quality metric.

Aspect 11 is the method of aspect 10, wherein aggregating the one or more per-beam quality metrics to obtain the second quality metric further comprises identifying a highest-beam cell in the one or more cells, wherein the highest-beam cell is associated with the highest per-beam quality metric; and obtaining at least one candidate quality metric from the one or more first quality metrics and at least one candidate cell from the one or more cells, wherein the at least one candidate quality metric is within a cell threshold range of the highest per-beam quality metric, and wherein the at least one candidate cell is associated with the at least one candidate quality metric.

Aspect 12 is the method of any of aspects 10 to 11, wherein combining the at least one per-beam quality metric to obtain the second quality metric comprises aggregating the at least one candidate quality metric across the at least one candidate cell to obtain one or more per-cell quality metrics, wherein each per-cell quality metric of the one or more per-cell quality metrics corresponds to one candidate cell of the at least one candidate cell; and aggregating the one or more per-cell quality metrics to obtain the second quality metric.

Aspect 13 is the method of aspect 10, wherein combining the at least one per-beam quality metric to obtain the second quality metric comprises performing, based on beam weights respectively associated with the at least one per-beam quality metric, a weighted averaging on the at least one per-beam quality metric to obtain the second quality metric.

Aspect 14 is the method of aspect 13, wherein the beam weights respectively associated with the at least one per-beam quality metric is based on one or more of a weight configuration from the network entity, predefined values, or an implementation on the UE.

Aspect 15 is the method of aspect 10, wherein the method further includes determining a report priority associated with the second quality metric, wherein the report priority is based on one or more of the second quality metric, the highest per-beam quality metric, or a number of per-beam quality metrics in the at least one per-beam quality metric within the first threshold range of the highest per-beam quality metric.

Aspect 16 is the method of aspect 3, wherein aggregating the one or more first quality metrics to obtain the second quality metric associated with the event comprises aggregating the one or more first quality metrics across the one or more beams to obtain one or more per-cell quality metrics, wherein each per-cell quality metric of the one or more per-cell quality metrics corresponds to one cell of the one or more cells; and aggregating the one or more per-cell quality metrics to obtain the second quality metric.

Aspect 17 is the method of aspect 16, wherein aggregating the one or more first quality metrics across the one or more beams to obtain the one or more per-cell quality metrics comprises identifying, for each cell of the one or more cells, a highest first quality metric among the one or more first quality metrics for the cell; obtaining, for each cell of the one or more cells, at least one first quality metric from the one or more first quality metrics based on a second threshold range to the highest first quality metric; and combining, for each cell of the one or more cells, the at least one first quality metric to obtain the one or more per-cell quality metrics.

Aspect 18 is the method of aspect 16, wherein aggregating the one or more per-cell quality metrics to obtain the second quality metric comprises identifying a highest per-cell quality metric among the one or more per-cell quality metrics; obtaining at least one per-cell quality metric from the one or more per-cell quality metrics based on a third threshold range to the highest per-cell quality metric; and combining the at least one per-cell quality metric to obtain the second quality metric.

Aspect 19 is the method of aspect 18, wherein combining the at least one per-cell quality metric to obtain the second quality metric comprises performing, based on cell weights respectively associated with the at least one per-cell quality metric, a weighted averaging on the at least one per-cell quality metric to obtain the second quality metric.

Aspect 20 is the method of aspect 18, wherein the method further includes determining a report priority associated with the second quality metric, wherein the report priority is based on one or more of the second quality metric, the highest per-cell quality metric, or a number of per-cell quality metrics in the at least one per-cell quality metric within the second threshold range of the highest per-cell quality metric.

Aspect 21 is an apparatus for wireless communication at a UE, comprising: at least one memory; and at least one processor coupled to the at least one memory, the at least one processor is configured to perform the method of any of aspects 1 to 20.

Aspect 22 is the apparatus for wireless communication at a UE, comprising means for performing each step in the method of any of aspects 1-20.

Aspect 23 is an apparatus of any of aspects 21-22, further comprising a transceiver configured to receive or to transmit in association with the method of any of aspects 1-20.

Aspect 24 is a computer-readable medium (e.g., a non-transitory computer-readable medium) storing computer executable code at a UE, the code when executed by at least one processor causes the at least one processor to perform the method of any of aspects 1-20.

Aspect 25 is a method of wireless communication at a network entity. The method includes receiving, from a user equipment (UE), a report comprising an event quality metric associated with an event, wherein the event quality metric is based on an aggregation of one or more first quality metrics, wherein each first quality metric of the one or more first quality metrics is associated with one beam of one or more beams of the UE and one cell of one or more cells associated with the network entity; and communicating with the UE based on the report.

Aspect 26 is the method of aspect 25, wherein the first quality metric is a first metric type and the second quality metric is a second metric type different from the first metric type, and wherein the method further comprises configuring, for the UE, a measurement resource corresponding to the second quality metric.

Aspect 27 is the method of any of aspects 25 to 26, wherein each first quality metric of the one or more first quality metrics is obtained based on one or more of a measurement result on the UE or a prediction or inference result from an artificial intelligence/machine learning (AI/ML) model.

Aspect 28 is an apparatus for wireless communication at a network entity, comprising: at least one memory; and at least one processor coupled to the at least one memory and, where the at least one processor is configured to perform the method of any of aspects 25-27.

Aspect 29 is the apparatus for wireless communication at a network entity, comprising means for performing each step in the method of any of aspects 25-27.

Aspect 30 is an apparatus of any of aspects 28-29, further comprising a transceiver configured to receive or to transmit in association with the method of any of aspects 25-27.

Aspect 31 is a computer-readable medium (e.g., a non-transitory computer-readable medium) storing computer executable code at a network entity, the code when executed by at least one processor causes the at least one processor to perform the method of any of aspects 25-27.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
obtain one or more first quality metrics, wherein each first quality metric of the one or more first quality metrics is associated with one beam of one or more beams and one cell of one or more cells; and
communicate with a network entity based on a second quality metric associated with an event, wherein the second quality metric is based on an aggregation of the one or more first quality metrics.

2. The apparatus of claim 1, further comprising a transceiver coupled to the at least one processor, wherein to communicate with the network entity based on the second quality metric, the at least one processor is configured to communicate with the network entity based on the second quality metric via the transceiver, and wherein the at least one processor is further configured to:
report, to the network entity, the second quality metric associated with the event.

3. The apparatus of claim 1, wherein the at least one processor is further configured to:
aggregate the one or more first quality metrics to obtain the second quality metric associated with the event.

4. The apparatus of claim 3, wherein to aggregate the one or more first quality metrics to obtain the second quality metric associated with the event, the at least one processor is configured to:
aggregate the one or more first quality metrics across the one or more cells to obtain one or more per-beam quality metrics, wherein each per-beam quality metric of the one or more per-beam quality metrics corresponds to one beam of the one or more beams; and
aggregate the one or more per-beam quality metrics to obtain the second quality metric.

5. The apparatus of claim 4, wherein the at least one processor is further configured to:
apply a first filtering on the one or more first quality metrics in a cell aggregation of the one or more first quality metrics across the one or more cells.

6. The apparatus of claim 4, wherein the at least one processor is further configured to:
determine a beam priority level for each beam of the one or more beams, wherein the beam priority level is based on one or more of:
a transmission configuration indicator (TCI) state activation of the beam, or
an early uplink timing advance acquisition of the beam.

7. The apparatus of claim 6, wherein to aggregate the one or more per-beam quality metrics to obtain the second quality metric, the at least one processor is configured to:
aggregate, based on the beam priority level for each beam of the one or more beams, the one or more per-beam quality metrics to obtain the second quality metric.

8. The apparatus of claim 4, wherein the first quality metric is a first metric type, and the second quality metric is a second metric type different from the first metric type, and wherein the at least one processor is further configured to:
receive a measurement resource corresponding to the second quality metric; and
measure the second quality metric on the measurement resource based on the aggregation of the one or more per-beam quality metrics.

9. The apparatus of claim 4, wherein each first quality metric of the one or more first quality metrics is obtained based on one or more of:
a measurement result on the UE, or
a prediction or inference result from an artificial intelligence/machine learning (AI/ML) model.

10. The apparatus of claim 4, wherein to aggregate the one or more per-beam quality metrics to obtain the second quality metric, the at least one processor is configured to:
identify a highest per-beam quality metric among the one or more per-beam quality metrics;
obtain at least one per-beam quality metric from the one or more per-beam quality metrics based on a first threshold range to the highest per-beam quality metric; and
combine the at least one per-beam quality metric to obtain the second quality metric.

11. The apparatus of claim 10, wherein to aggregate the one or more per-beam quality metrics to obtain the second quality metric, the at least one processor is further configured to:
identify a highest-beam cell in the one or more cells, wherein the highest-beam cell is associated with the highest per-beam quality metric; and
obtain at least one candidate quality metric from the one or more first quality metric and at least one candidate cell from the one or more cells, wherein the at least one candidate quality metric is within a cell threshold range of the highest per-beam quality metric, and wherein the at least one candidate cell is associated with the at least one candidate quality metric.

12. The apparatus of claim 11, wherein to combine the at least one per-beam quality metric to obtain the second quality metric, the at least one processor is configured to:
aggregate the at least one candidate quality metric across the at least one candidate cell to obtain one or more per-cell quality metrics, wherein each per-cell quality metric of the one or more per-cell quality metrics corresponds to one candidate cell of the at least one candidate cell; and
aggregate the one or more per-cell quality metrics to obtain the second quality metric.

13. The apparatus of claim 10, wherein to combine the at least one per-beam quality metric to obtain the second quality metric, the at least one processor is configured to:
perform, based on beam weights respectively associated with the at least one per-beam quality metric, a weighted averaging on the at least one per-beam quality metric to obtain the second quality metric.

14. The apparatus of claim 13, wherein the beam weights respectively associated with the at least one per-beam quality metric is based on one or more of:
a weight configuration from the network entity,
predefined values, or
an implementation on the UE.

15. The apparatus of claim 10, wherein the at least one processor is further configured to:
determine a report priority associated with the second quality metric, wherein the report priority is based on one or more of:
the second quality metric,
the highest per-beam quality metric, or
a number of per-beam quality metrics in the at least one per-beam quality metric within the first threshold range of the highest per-beam quality metric.

16. The apparatus of claim 3, wherein to aggregate the one or more first quality metrics to obtain the second quality metric associated with the event, the at least one processor is configured to:
aggregate the one or more first quality metrics across the one or more beams to obtain one or more per-cell quality metrics, wherein each per-cell quality metric of the one or more per-cell quality metrics corresponds to one cell of the one or more cells; and
aggregate the one or more per-cell quality metrics to obtain the second quality metric.

17. The apparatus of claim 16, wherein to aggregate the one or more first quality metrics across the one or more beams to obtain the one or more per-cell quality metric, the at least one processor is configured to:
identify, for each cell of the one or more cells, a highest first quality metrics among the one or more first quality metrics for the cell;
obtain, for each cell of the one or more cells, at least one first quality metric from the one or more first quality metric based on a second threshold range to the highest first quality metric; and
combine, for each cell of the one or more cells, the at least one first quality metric to obtain the one or more per-cell quality metric.

18. The apparatus of claim 16, wherein to aggregate the one or more per-cell quality metrics to obtain the second quality metric, the at least one processor is configured to:
identify a highest per-cell quality metrics among the one or more per-cell quality metrics;
obtain at least one per-cell quality metric from the one or more per-cell quality metrics based on a third threshold range to the highest per-cell quality metric; and
combine the at least one per-cell quality metric to obtain the second quality metric.

19. A method of wireless communication at a user equipment (UE), comprising:
obtaining one or more first quality metrics, wherein each first quality metric of the one or more first quality metrics is associated with one beam of one or more beams and one cell of one or more cells; and
communicating with a network entity based on a second quality metric associated with an event, wherein the second quality metric is based on an aggregation of the one or more first quality metrics.

20. An apparatus for wireless communication at a network entity, comprising:
at least one memory; and
at least one processor coupled to the at least one memory and, based at least in part on information stored in the at least one memory, the at least one processor is configured to:
receive, from a user equipment (UE), a report comprising an event quality metric associated with an event, wherein the event quality metric is based on an aggregation of one or more first quality metrics, wherein each first quality metric of the one or more first quality metrics is associated with one beam of one or more beams of the UE and one cell of one or more cells associated with the network entity; and
communicate with the UE based on the report.
